(19) United States
(12) Patent Application Publication
(10) Pub. No.: US 2011/0046889 A1
(43) Pub. Date: Feb. 24, 2011

(54) ENVIRONMENTAL MONITORING SYSTEM FOR CANINES, FELINES, OR OTHER ANIMALS

(76) Inventors: Donald Ray Bryant-Rich, Haifa (IL); Diana Eve Barshaw-Rich, Haifa (IL)

Correspondence Address: Donald R. Bryant-Rich, 15 Harub Street, West Carmel, Haifa, 34326, IL

(21) Appl. No.: 12/543,521

(22) Filed: Aug. 19, 2009

(51) Int. Cl. G06F 15/00; G06F 19/00

(52) U.S. Cl. 702/19; 702/188

(57) ABSTRACT

An apparatus for measuring, storing and communicating measurements of a dog, cat, other animal or inanimate object's environment. The apparatus may take the form of a collar, bridle, tag, harness or other mechanism worn by the animal or a device to be shipped with the animal or inanimate object. The apparatus may include mechanisms to initiate and terminate measurement and may include the ability to detect and report values exceeding specified limits.

### BACKGROUND OF THE INVENTION

### Field of the Invention

The present invention relates to a system for monitoring the environment of an animal.

At times the owner of a pet, other animal must relinquish control of the pet, etc. to another person. Examples include when the animal must be shipped or placed in a holding facility such as a kennel, quarantine facility or animal hospital. At these times the owner loses the ability to reliably know the environmental conditions endured by the animal. Poor handling may lead to exposure of the animal to dangerous or deadly conditions such as extreme temperatures, dropping, radiation, shock or loss of pressure (when shipped by air). Even in the event of normal handling, the animal owner may wish to know the handling and activity of the animal for peace of mind.

Equivalently, the entity entrusted with the care of the animal may use the system to record the handling and environmental conditions to which the animal is exposed to demonstrate proper handling and care.

The environmental monitoring system may also be used to monitor behavior and activity of an animal.

The environmental monitoring system may also be used to monitor the handling of inanimate objects sensitive to damage from handling and environmental conditions.

Similar systems exist in the art for the sensing of an animal's environment and activity for purposes of training. Training requires immediate feedback to the animal and therefore requires a constant stream of data and/or the observation of the animal by a trainer. Neither is required for monitoring the environment of an animal when it is not under observation.

### SUMMARY

These and other problems are solved by a system for collecting the values of environmental parameters possibly including temperature, humidity, pressure, acceleration, etc. These values can either be stored for subsequent transfer to an external host for processing or processed by the system for detection of violation of specified limits.

If the values are transferred to an external host the processing may include the detection of behavior patters such as running, playing, sleeping, eating, etc.

The environmental monitoring system may either be wearable by the animal (e.g. a collar, harness, or tag) or be designed to be placed in the animal's surroundings such as attached to a kennel or placed in the floor of a kennel.

The environmental monitoring system may include switches or other means of indicating the initiation and/or termination of monitoring. Examples include switches, use of accelerometers to detect gestures or taps.

If the system incorporates limit detection it may additionally provide an indication that the limits have been exceeded (or not) though the use of lights, buzzers, vibrators or wired or wireless communications interfaces.

If the system stores the environmental values it may also incorporate a wired or wireless communications interface used to transfer the values to a separate host for review, analysis and storage.

### BRIEF DESCRIPTION OF THE DRAWINGS

FIG. 1 shows various elements of an environment monitoring system.

FIG. 2 is a block diagram of the dog collar from FIG. 2 with the addition of a switch, tamper detector and limits exceeded indicator.

FIG. 3 is a drawing of environment monitoring system in the form of a dog collar.

FIG. 4A is a drawing of the environment monitoring system in a form to be placed in the animal's container.

FIG. 4B is a drawing of the environment monitoring system in a form to be attached to the animal's container.

FIG. 5A is a flow diagram representing a progression though the modes of operation of the environmental monitoring system.

FIG. 5A is a flow diagram representing a progression though the modes of operation of the environmental monitoring system with an additional low power mode.

FIG. 6 is a representation of an application used to review and analyze environmental data on an external host.

### DETAILED DESCRIPTION

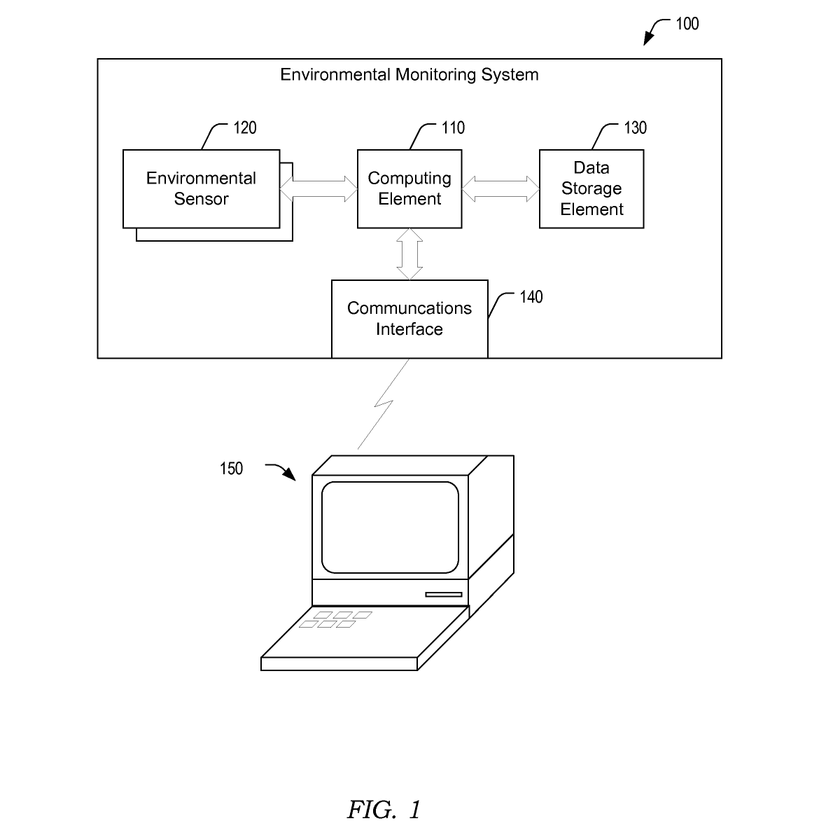

FIG. 1 show various elements of an environmental monitoring system 100 for tracking the handling of a pet, or animal. For purposes of explanation and not by way of limitation, the system 100 is described herein as an environmental monitoring system for dogs. Such a system may be used to determine if the dog has been mishandled or neglected when in the care of someone other than the owner such as when the dog is shipped or placed in a kennel. One of ordinary skill in the art will recognize that various aspects of the system can also be used for cats, other pets, farm animals, livestock, zoo animals, other animals or inanimate objects.

The system minimally contains a computing element 110 used to control the environmental monitoring system 100 and one or more environmental sensors 120, a data storage element 130 used to store values read from the environmental sensors 120 and a communications interface 140 used to transfer the stored environmental values to a separate host 150 for long term storage and/or analysis.

The environmental sensors 120 includes one or more sensors capable of providing a value related to an environmental condition. Example sensors include light, heat, radiation (visible, infrared, ultraviolet, ionizing, non-ionizing), magnetic field, pressure, position, acceleration, sound, sound intensity, and vision (still and motion images).

A position sensor, such as a GPS receiver, may be incorporated into the environmental monitoring system 100 to allow the tracking of the animal or coordination of the data reported by other sensors with the position of the animal.

The communication interface 140 is used to communicate status, values read from the environmental sensors 120 and may be used to control the mode of operation of the environmental monitoring system 100. The communication interface may be implemented using any available method including wired communications (Universal Serial Bus, RS232, RS485, RS488, IEEE 1394) or wireless (examples include Wireless USB, Zigbee, Z-wave, IEEE 802.11 and Bluetooth).

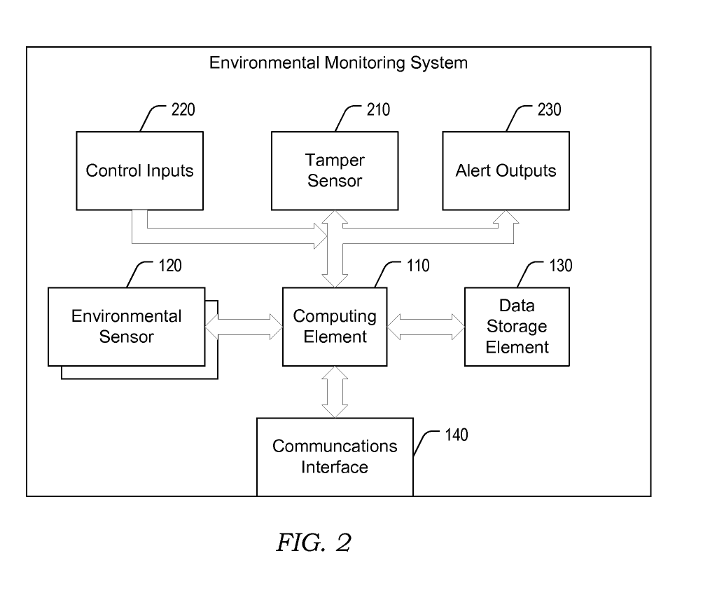

FIG. 2 extends the environmental monitoring system 100 with the addition of control inputs, alert outputs and a tamper sensor.

An optional tamper sensor 210 control input senses when the system has been tampered with (e.g. removed from the animal). If present the same sensor used to detect tampering may be used as a control input for altering the operating mode of the system, for example by transitioning to the measurement mode when the system is placed on the animal.

Control inputs 220 such as switches and buttons may be used to control operation of the system. Such control inputs may be used to control power to the environmental monitoring system, start and stop recording, change mode of operation or control environmental limits used to characterize the environmental conditions.

Alert outputs 230 using lights, buzzers, or vibrators may indicate operational status or violation of specified environmental limits.

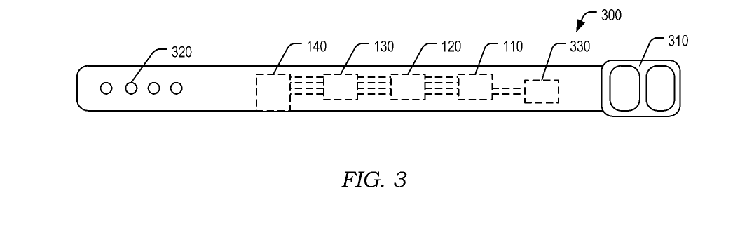

FIG. 3 provides a representation of one embodiment of environment monitoring system 100 wherein the system is enclosed in a representative wearable form of a dog collar 300. Equivalent embodiments may be in the form of a harness, tag, or other wearable object or in a form for attachment to such wearable objects.

This embodiment of the environmental monitoring system is a collar attachable to the dog or other animal using a buckle 310 with matching holes 320 for closure and length adjustment. The components of the environmental monitoring system 110 to 140 are embedded in or attached to the collar. The collar 300 also incorporates a power supply such as a battery 330.

In this embodiment control is provided through the use of the communication interface 140 to place the environmental monitoring system in an initial state wherein environmental data is not recorded and one or more of the environmental sensors 120 are used to initiate environmental data recording. Initiation may be done by detecting one or more taps or gestures using an acceleration sensor, by detecting altitude changes using a pressure sensor, by detecting a specific sound using a sound sensor or by detecting any other condition not normally present before data recording is required.

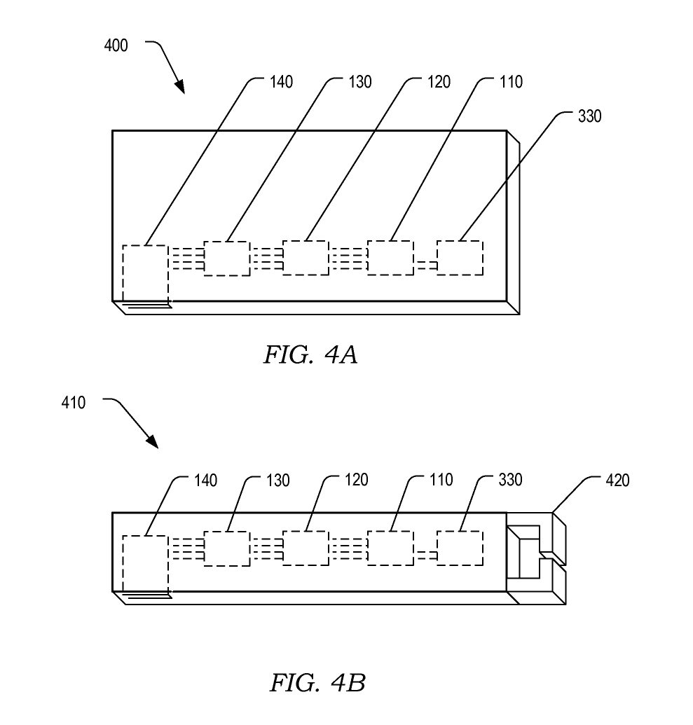

FIG. 4A provides a representation 400 of one embodiment of environment monitoring system 100 wherein the system is enclosed in a form which may inserted into the immediate area of the dog or other animal. For example, the environmental monitoring system may be formed to fit between the floor and shell of a kennel.

FIG. 4B provides a representation of one embodiment 410 of environment monitoring system 100 wherein the system is enclosed in a form which may attached to the immediate area of the dog or other animal. For example, the environmental monitoring system may be formed to be attached to the bars of a kennel. One method for such attachment would be the incorporation of a split ring 420 into the body or shell of the environmental monitoring system 100. Alternative attachment methods may include a locking mechanism, adhesive, hook and ring fabric and may be permanent or reversible.

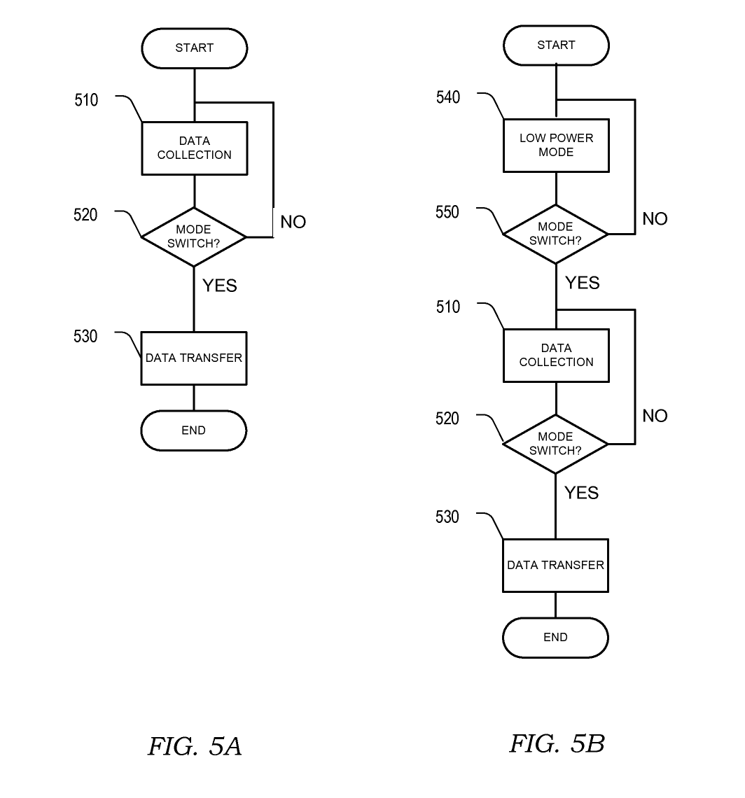

In one embodiment, exemplified by FIG. 5A, the environment monitoring system 100 provides two operating modes, a first operating mode 510 for taking sensor measurements (and storing such measurements if a data storage element 130 is incorporated in the system), and a second mode 530 for transferring stored measurements or alerts to an external host for review, analysis and storage. The selection of the operating mode 520 may be made by a switch or other input such as detection of a gesture, tapping, or removing the collar from the animal, or by the activation of the communications interface such insertion of a USB cable or the negotiation of a wireless connection to the host.

When in the measurement mode the computing element 110 continuously or periodically reads values from the environment sensors 120 and processes the values. Processing may include storing the value in the data storage element 130 if present and/or comparison of the values to specified limits. If the limits are exceeded an alert may be stored in the data storage element 130, output using the alert outputs 230 or communicated using the communications interface 140.

While in the measurement mode control inputs including but not limited to switch inputs, gestures and taps may be used to trigger indication of alerts or to terminate the measurement mode.

When in the communications mode the computing element 110 is used to transfer stored values and/or alerts from the data storage element 130 to the communications interface 140 for transfer to an external host.

In another embodiment, FIG. 5B, the environment monitoring system 100 provides an additional low power operating mode 540 used to detect control inputs. In this mode the computing element 100 is minimally active for sensing control inputs. The control inputs 220 may be from a switch or equivalent effector, or may be through changes in the environmental sensors 120 such as detection of a gesture, tap, or change in position, pressure, etc. Upon detection of the appropriate control input 550 the environment monitoring system in placed in a the data collection mode.

Alternative embodiments may also use the mode switch inputs 520 and 550 to power down the environmental monitoring system. If the mode switch inputs 520 and/or 550 are present at start the environmental monitoring system may transition to the data collection 510 or data transfer 530 modes immediately after start.

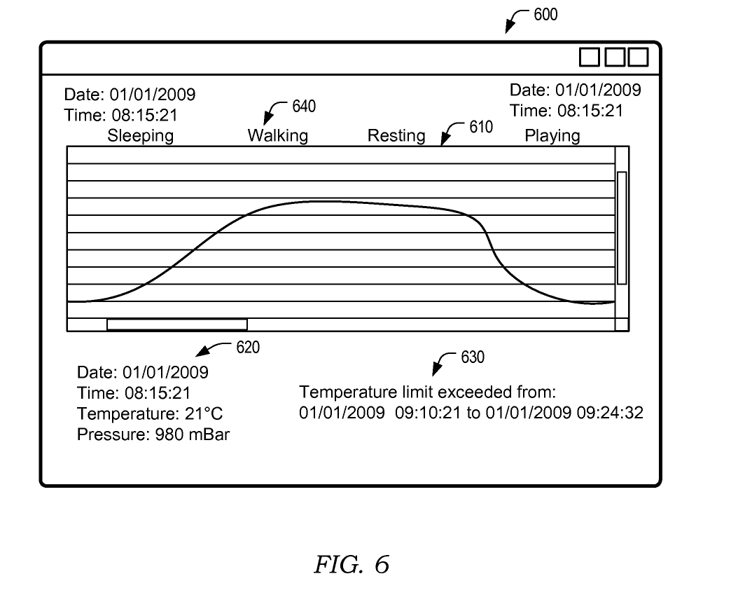

FIG. 6 presents a stereotypical application used to review and analyze environmental data transferred from the environmental monitoring system 100 to an external host 150.

The application 600 used to process the values communicated from the environment monitoring system may allow display of the values as a time sequence 610 or at specified times 620. In addition the application may detect and display values exceeding specified limits 630. The application may also use the values to detect behaviors 640 such as running, playing, sleeping, eating, etc.

The environmental data transferred from the environmental monitoring system 100 may be digitally signed to provide verification of the source environmental system, time of recording and that the data values are unchanged. The digital signature may be calculated using any digital signing algorithm by including a unique environmental signature identifier and date/time values in the data to be signed.

Although various embodiments have been described above, other embodiments will be within the skill of one of ordinary skill in the art. Thus, although described in terms of a dog, such description was for sake of convenience and not by way of limitation. One of ordinary skill in the art will recognize that all or part of the system 100 can be applied to other animals, such as, for example, cats, livestock, zoo animals, farm animals, etc. Thus, the invention is limited only by the claims that follow.

1. An environment monitoring system, comprising: a computing element, one or more environmental sensors and a data storage element; said animal environment monitoring system configured to read values from said environmental sensors and store the values in said data storage element.

2. The system of claim 1, said environment monitoring system further comprising an temperature sensor device.

3. The system of claim 1, said environment monitoring system further comprising an pressure sensor device.

4. The system of claim 1, said environment monitoring system further comprising an humidity sensor device.

5. The system of claim 1, said environment monitoring system further comprising an motion sensor device.

6. The system of claim 1, said environment monitoring system further comprising an position sensor device.

7. The system of claim 1, said environment monitoring system further comprising an radiation sensor.

8. The system of claim 1, said environment monitoring system further comprising an radiation sensing unit.

9. The system of claim 1, said environment monitoring system further comprising an sound sensor.

10. The system of claim 1, said environment monitoring system further comprising an image recording device.

11. The system of claim 1, said data storage element is removable.

12. The system of claim 1, said environment monitoring system further comprising a wired or wireless communications interface.

13. The system of claim Error! Reference source not found. 12, wherein said communications interface is a wired interface.

14. The system of claim 12, wherein said communications interface is a wireless interface.

15. The system of claim 1, said computing element programmed to compare said environmental values read to specified limits.

16. The system of claim 15, said computing element programmed to store an alert.

17. The system of claim 15, said environment monitoring system further comprising an effector allowing communication of said stored alert.

18. The system of claim 1, said data storage element stores a digital signature attesting to the validity of the sensor data stored in said data storage element.

19. The system of claim 1, wherein said animal system is wearable by an animal.

20. The system of claim 1, wherein said animal system is shippable with an animal.
